(19) United States
(12) Patent Application Publication
(10) Pub. No.: US 2022/0134728 A1
(43) Pub. Date: May 5, 2022

(54) Method for introducing weaknesses into a decorative material

(71) Applicant: EISSMANN AUTOMOTIVE DEUTSCHLAND GMBH, BAD URACH (DE)

(72) Inventor: JENNIFER TOPP, PFULLINGEN (DE)

(21) Appl. No.: 17/452,612

(22) Filed: Oct. 28, 2021

(30) Foreign Application Priority Data
Oct. 30, 2020 (DE) DE 102020128595.7

(51) Int. Cl. B32B 38/04; B32B 3/26; B32B 9/02; B32B 9/04; B32B 5/02; B32B 41/00; B32B 27/30; B32B 27/40; B60R 21/2165; B23K 26/386; B23K 26/402

(52) U.S. Cl. CPC B32B 38/04; B23K 2103/42; B32B 9/025; B32B 9/045; B32B 5/024; B32B 9/047; B32B 41/00; B32B 27/304; B32B 27/40; B60R 21/2165; B23K 26/386; B23K 26/402; B32B 2451/00; B32B 2605/003; B32B 2310/0843; B32B 2038/047; B32B 2327/06; B32B 2375/00; B32B 2317/08; B32B 2307/54; B32B 3/266

(57) ABSTRACT

The invention relates to a method for introducing weaknesses into a decorative material comprising a decorative layer and a carrier layer, preferably used for airbag coverings in motor vehicles, wherein the method comprises the following steps:
a) introducing different weaknesses (21) by means of a laser (20) into sections (30) of the decorative material (10) for test purposes, wherein the different weaknesses (21) differ from one another in that the different weaknesses (21) are introduced using different parameters of the laser (20);
b) measuring the tear properties of the sections (30);
c) determining which section (30) which has a desired tear property and associating the relevant parameters of the laser (20) with this section (30);
d) setting the laser (20) at the parameters associated in accordance with e);
e) introducing weaknesses (22) into the decorative material (10) by means of the laser (20) set in accordance with step e).

### CROSS-REFERENCE TO RELATED APPLICATIONS

This application claims priority to German patent application: DE 10 2020 128 595.7, filed 30 Oct. 2020, having a common inventor and currently pending.

### STATEMENT REGARDING FEDERALLY SPONSORED RESEARCH OR DEVELOPMENT

Not Applicable.

### BACKGROUND OF THE INVENTION

### Field of the Invention

The present invention relates to a method for introducing weaknesses into a decorative material as well as a use of such a decorative material as an airbag cover in motor vehicles.

### Description of Related Art

Airbags are now being integrated into various areas of motor vehicles, e.g., steering wheels, dashboards, doors, etc. For the airbag to function reliably, it is necessary for all layers of the plastic carrier to comprise one or more material weaknesses, so-called “predetermined breaking points” which define the airbag's firing channel.

Conventionally, the plastic carrier of the airbag is covered with a decorative covering or a decorative composite. However, this covering must likewise comprise a material weakness in the area of the edge of the airbag flap so as to guarantee the safe opening of the airbag flap and the deployment of the airbag in the event of an impact.

In addition, the opening of the covering along the weakened material must take place within a specified timeframe. Also, an uncontrollable shower of particles due to fragments of the covering flying about must definitely be avoided.

The known decorative coverings of this kind are made of different materials, e.g., plastic films, cover materials, textiles, slush material, artificial leather, or leather.

These functional requirements, in addition to simultaneously adhering to design specifications that the material weakness be invisible, represent a large technical challenge.

Lasers, for example CO2 lasers, are used for weakening, as is already known from the prior art. In order to introduce the weaknesses in a defined manner, the prior art proposes the homogenization of, for example, artificial leather by means of pressure and/or temperature prior to introducing the weakness.

Another option is that of regulating the laser during the weakening process, i.e., while continuously monitoring the weakening process, either adjusting parameters such as intensity and pulse frequency during the weakening procedure, or switching off the laser at the points of impact on the decorative material where the desired residual wall thickness has already been reached.

For example, U.S. Pat. No. 5,744,776 describes a method in which the laser used to introduce the weakness is regulated such that the composite is only weakened to a defined residual wall thickness.

DE 196 36 429 C1 describes a method for generating a line of weakness in a cover material by the single-sided local removal of the coating material in the form of blind holes by means of controllable pulsed laser radiation, in which case a relative movement between the laser beam and the cover material takes place in the direction of the line of weakness being generated, and the laser radiation transmitted to the bottom of the respective blind hole is detected by means of a sensor after each laser pulse, the integral value is formed and compared to a target value, and the laser beam is switched off when the target value is reached, and, after the relative movement has taken place, is switched on again at the next blind hole yet to be weakened.

Known from DE 2019 113 849 A1 is a method for introducing a weakness into a decorative material. In the method therein, the residual wall thickness is regulated in a sensor-controlled manner. The laser beams are switched off when a reference value is reached.

Known from DE 10 2006 054 587 A1 is a targeted weakness of selectively pretreated spacer fabrics by means of a laser, in which case the pretreatment of the spacer fabrics takes place, for example, by means of additional threads, by using flame retardants, or by increasing or decreasing the temperature.

Airbag weaknesses in leather using sharpening and cutting are known from DE 10 2007 017 602 A1. Consequently, the methods known from the prior art use regulated lasers. In this context, the progress of the introduction of the weakness must be measured in a complex manner before switching off the laser in areas where the desired weakness has already been achieved.

Devices with regulated lasers having the relevant measuring devices are very expensive, which has an unfavorable effect on the unit price of weakened decorative materials.

### BRIEF SUMMARY OF THE INVENTION

The object of the invention is to provide a cost-effective method of introducing weaknesses into a decorative material, in which the decorative material reliably tears along the weaknesses, and the decorative material is visually appealing.

This object is achieved in one embodiment, by the features of a method according to the invention comprising the following steps:
a) providing a decorative material comprising a decorative layer and a carrier layer;
b) providing a laser;
c) introducing different weaknesses by means of the laser into sections of the decorative material for test purposes, with the different weaknesses different from one another in that the different weaknesses are introduced using different laser parameters;
d) measuring the tear properties of the sections;
e) determining which section has a desired tear property and associating the relevant parameters of the laser with this section;
f) setting the laser at the parameters associated in accordance with e);
g) introducing weaknesses into the decorative material by means of the laser set in accordance with step f), with the laser not being regulated during the introduction of the weakness.

Given that the method according to the invention is used to determine the laser parameters before the actual weakening of the decorative material, it is possible to dispense with complex measurements during the laser process. As a result, the laser need not be regulated during the weakening process, so an unregulated laser can be used, and costly regulated lasers and complex measuring procedures can be dispensed with.

At the beginning of the method according to the invention, a flat decorative material is provided which comprises a decorative layer and a carrier layer. The decorative material can comprise further layers. For example, the carrier layer can be connected to the decorative layer using an adhesive layer, or a haptic layer can be arranged between the carrier layer and the cover layer.

Conventionally, the decorative material consists of at least two layers—a carrier layer and a decorative layer. The visible side of the decorative layer comprises the design visible to an observer, for example a grain structure. However, a protective layer, for example a paint, can also be arranged on the decorative layer. However, this layer is usually transparent, so the design of the decorative layer remains visible.

Surprisingly, it was discovered that, in the method according to the invention, in particular with artificial leather or Alcantara as a decorative material, it is sufficient to weaken only the carrier layer in order to obtain decorative materials which meet the complex requirements for airbag coverings.

The decorative layer is preferably made of a plastic such as polyvinylchloride (PVC). Particularly preferably, the decorative layer is made of polyurethane (PUR). The decorative surface, meaning the visible side of the decorative layer facing away from the carrier layer, can have a grain or be smooth.

The carrier layer can be a polymer layer, textile, nonwoven fabric, fiber-polymer mixture, foam material, natural fiber, natural fiber mixture, (micro) fiber mesh, knitted spacer fabric, or a combination thereof, and it typically does not serve as a decorative surface. The carrier layer rather serves to stabilize the decorative layer.

In addition to the above materials, the carrier layer can also be a thermoplastic (nonlimiting examples including: polyester (PES), polyethylene terepthalate (PET), Polycarbonate (PC), polyamide (PA), polymethylmethacrylate (PMMA), polyurethane (PUR), silicone, or a combination thereof) or other thermoplastic resins.

Both the decorative layer and the carrier layer can have a multilayer design.

The decorative material according to the invention in a preferred embodiment is preferably synthetic or artificial leather or Alcantara.

“Artificial leather” is understood to mean a textile and flexible sheet-like structure produced using plastic materials and designed in accordance with the intended use. This does not mean that natural materials cannot also be included in the surface structure constituting the artificial leather. Therefore, this can, for example, be a combination of a decorative layer made of plastic and one or multiple layers of a textile made of natural fibers.

However, in a preferred embodiment, the artificial leather preferably comprises a decorative layer made of plastic and a carrier layer made of textile, since the present invention is particularly suitable for such artificial leather.

In the context of the method according to the invention, a pulsed UV laser is preferably used, in which case a solid-state laser with a wavelength of 355 nm or an excimer laser with a wavelength of 351 nm, 308 nm, or 248 nm is particularly preferable.

However, CO2 lasers, erbium YAG lasers, or IR lasers can also be used.

In the case of UV lasers, the preferable wavelength is less than 400 nm. In the case of an IR laser, the wavelength can preferably be greater than 700 nm.

In the context of weaknesses for test purposes (test weaknesses), weaknesses or weakness lines are, using the laser, introduced into sections of the decorative material provided for the test weaknesses.

In the context of the invention, “sections” are understood to mean a region of the decorative material, or also an individual piece of decorative material.

This preferably relates to the same decorative material into which the weaknesses are intended to subsequently be introduced, hence, for example, the same batch of decorative material, because the tear properties cannot be determined non-destructively, and the sections provided for the test weaknesses are then discarded.

The sections of the decorative material can be shaped so that they are able to be used in the relevant material testing machines, meaning that the sections can be identical to the test surface inserted into the material testing machine. However, a section can also comprise one or more areas having test surfaces.

Preferably, multiple sections and/or multiple test surfaces are weakened on a section for test purposes in order to be able to perform a statistical evaluation with a suitable number of samples.

The different weaknesses for test purposes differ in that they are introduced using different laser parameters. For this purpose, the parameters of the laser are set and subsequently one or multiple sections are weakened. The parameters of the laser are then changed, and one or multiple sections are weakened as before.

Particularly preferably, various laser settings are tested with respect to the pulse frequency, power, and frequency at which the laser beam is lasered onto a target location. These parameters can be changed individually or in combination.

In the preferred use of a UV solid-state laser with a wavelength of 355 nm, the power is conventionally 4 to 5 watts, the pulse frequency is 10 to 70 kH, the pulse width is 400 to 600 μs, and the velocity is 20 to 500 mm/s.

The tear properties of the sections of the decorative material that were weakened for test purposes are measured in order to determine the parameters at which the laser should be set so as to introduce the actual weaknesses into the decorative material.

Preferably, the sections of the decorative material are caused to tear. Impact tests, static tensile tests or, particularly preferably, dynamic impact tensile tests can be used for this purpose.

Conventionally, the tensile break strength is between 20 N/cm2 and 150 N/cm2, particularly preferably between 50 N/cm2 and 100 N/cm2.

In tensile tests, the tensile direction preferably runs perpendicular to the line of weakness, or to the mean progression of the line of weakness.

Insofar as the decorative material has a preferred direction in relation to elasticity, the positioning of the line of weakness in relation to this preferred direction should be introduced equally both in the decorative material in the sections for test purposes and in accordance with step g).

As a consequence, it can be ensured that the result of the measurement of the tear properties is applied as precisely as possible to the weaknesses in the decorative material.

Particularly preferably, the line of weakness is introduced into the sections in such a way that the line of weakness or the mean progression of the line of weakness is perpendicular to the direction of lowest elasticity of the decorative material. Doing so can prevent an excessively large portion of the energy which must be applied in order to tear the decorative material from being spent on stretching the material.

After the tear properties have been measured, the section whose tear property corresponds to a desired tear property is determined. The relevant laser parameters at which the laser was set can then be associated with this specific section in order to introduce test weaknesses into this specific section.

The laser is set at these associated parameters and, as a result, these parameters are adopted as a laser presetting for the subsequent introduction of weaknesses into the decorative material.

The decorative material is, in accordance with step g), weakened using the laser set at the parameters determined in step e).

As a result, the weaknesses are introduced into the decorative material without the laser being regulated.

Surprisingly, it was discovered that the method according to the invention also requires no pretreatment of the decorative material. As a result, the decorative material must neither be homogenized nor heat-treated.

In one embodiment of the invention, the success of the weakening of the decorative material can be verified at random inspections using the aforementioned tests. For example, a verification can take place for each batch of decorative material, for each daytime shift, or even more than once for each batch or daytime shift, etc.

If the tear properties in the random check are not within the limits set for the tear strength of the decorative material, the method is performed again, starting with step c).

A decorative material weakened according to the invention meets the highly sensitive pre-selected requirements placed upon decorative materials for airbag coverings. The weaknesses are thus essentially not visible from the visible side, and the decorative material tears in a defined and reliable manner when the airbag is triggered. As a result, the decorative material weakened according to the invention can preferably be used as a cover material for airbag coverings in motor vehicles.

According to the invention, the decorative material is weakened as a result of the weaknesses being blind holes, with the blind holes essentially being introduced into the carrier layer, and the decorative layer essentially being unweakened.

According to the invention, the weaknesses are introduced into the carrier layer from the side facing away from the decorative layer, hence from the rear side of the carrier layer.

In the context of the present invention, “blind holes” are understood to mean each hole introduced into the decorative material that is not a through-hole.

Given that, according to a preferential embodiment, the carrier layer is a textile and the threads of said textile can comprise knots, etc., blind holes are then still present even when nearly all of the holes introduced are blind holes, even if the laser actually ends up crossing through to the other side of quite small portions of the material in some locations. The feature “with the blind holes essentially being introduced into the carrier layer, and the decorative layer essentially being unweakened” should be understood in this way.

Due to the possibility of inhomogeneity in the carrier layer, the depth of the weaknesses, or rather the blind hole, can in particular correspond to the thickness of the carrier layer multiplied by from 0.8 to 1.2. According to the invention, the carrier layer is considered to be “essentially” completely weakened, and the decorative layer is “essentially” unweakened.

From a statistical point of view, the result is, in effect, a complete weakening of the carrier layer without the decorative layer being weakened thereby.

The laser parameters are preferably selected such that the decorative layer will not be perforated even if the laser beam penetrates between two threads and through the carrier layer, i.e., passing through the center of a “mesh” and striking subsequent layers.

Since the decoration layer is essentially unweakened, the risk that the weakness will be visible is thus further reduced.

The blind holes can be elongated (slit-shaped), oval, round, rectangular, square, or otherwise shaped, e.g., curved. Preferably, the blind holes are elongated when viewed from above, with a slit length of between 0.2 mm and 2.0 mm, preferably between 0.3 mm and 1.0 mm, and particularly preferably between 0.5 mm and 0.8 mm and arranged on a line of weakness.

The diameter (or, in the case of a slit-shaped blind hole, the width of the slit) of a blind hole can be between 0.1 mm and 2.0 mm, preferably between 0.3 mm and 1.0 mm, and particularly preferably between 0.5 mm and 0.8 mm.

In order to avoid shrink marks and visible weaknesses on the decorative layer, crosspieces are arranged on the line of weakness which are preferably between 0.2 mm and 1.0 mm long, preferably between 0.3 mm and 0.8 mm long, and particularly preferably between 0.4 mm and 0.6 mm long.

The depth of a blind hole depends upon the thickness of the carrier layer. Preferably, essentially only the carrier layer should be completely weakened, i.e., the depth of the blind hole should correspond to the thickness of the carrier layer.

In general, the carrier layer has a thickness of between 0.2 mm and 0.8 mm, preferably between 0.3 and 0.7 mm, and particularly preferably between 0.4 and 0.6 mm.

The thickness of the decorative material can be between 0.2 mm and 1.0 mm, preferably between 0.4 and 0.8 mm, and particularly preferably between 0.5 and 0.7 mm.

The invention as well as further advantageous embodiments and developments thereof will be described and explained in more detail hereinafter with reference to the examples shown in the drawings. The features to be inferred from the description and the drawings can be applied individually or collectively in any combination according to the invention.

### BRIEF SUMMARY OF THE INVENTION

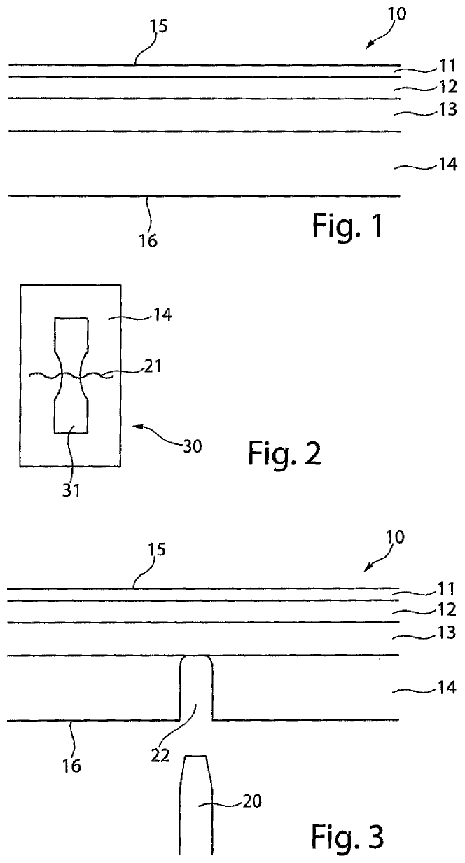

FIG. 1 a section through the decorative material,

FIG. 2 a plan view of the rear side of a section of the decorative material, and

FIG. 3 a section through the weakened decorative material.

FIG. 1 shows, schematically in section, a decorative material 10 having a lacquer layer 11, a decorative layer 12, thereunder a haptic layer 13, and a carrier layer 14.

The lacquer layer 11 is transparent, so the design of the visible side 15 is determined by the decorative layer 12.

The rear side 16 of the decorative material 10 is formed by the carrier layer 14.

The decorative material 10 provided in accordance with step a) is in this embodiment an artificial leather. The artificial leather comprises a decorative layer 12 made of polyurethane (PUR). The carrier layer 14 is a textile, in this case preferably consisting of cotton fibers or polyester (PES) fibers.

FIG. 2 shows a plan view of a section 30 of the decorative material 10, specifically of the carrier layer 14 of the decorative material 10, i.e., the rear side 16 of the decorative material 10. In FIG. 2, the section 30 is a rectangular piece of decorative material 10. A test surface 31 is marked on the section 30. The test surface 31 in this embodiment is club-shaped so that its broad ends can be clamped by a material testing machine.

A solid-state UV laser 20 provided after step b) with a wavelength of 355 mm is set with a parameter or parameter combination in order to, for test purposes, introduce a first weakness 21 into the carrier layer 14 from the rear side 16 and into the section 30. The test weakness 21 is introduced as centrally as possible within the test surface 31.

The parameters or parameter combinations are then changed and, similar to the first weakness 21, a second, different weakness 21 is introduced into the carrier layer 14 from the rear side 16 and into a second section 30 of the decorative material 10 (not shown).

In order to test further parameters for the laser 20, further sections 30 are weakened for test purposes (not shown).

Preferably, the section 30 includes multiple test surfaces 31 which can be weakened in one pass at the set parameters for the laser 20 in order to be able to perform a statistical evaluation with a suitable number of random samples.

The weaknesses 21 run along the approximate middle of the tapered areas of the test surfaces 31.

For testing in the material testing machine, the test surfaces 31 are detached, e.g. cut, from the sections 30 and successively clamped by their widened ends in a materials testing machine.

The individual test surfaces 31 are destroyed by means of an impact tensile test, and the tear energy is determined. The tear properties of the sections 30 having different weaknesses 21 are thus determined.

Conventionally, the tearing energy that must be applied in order to cause the test surfaces 31 to tear along the weaknesses 21 is between 0.4 joules and 0.9 joules.

If the desired and pre-selected tear property is then tearing at a tear energy of between 0.4 joules and 0.9 joules, this will then be associated with a corresponding section 30 on the basis of the average values of the measured tear energy of the test surfaces 31. The parameters for the laser 20, by means of which the weaknesses 21 were introduced, are then known for this section 30.

The impact tensile testing thus determines the parameters for the laser 20 which must be set in order to produce weaknesses 22 in the decorative material 10 such that the decorative material 10 weakened in accordance with step g) has the desired tear properties.

Once the parameters for the laser 20 have been determined, the laser 20 is permanently set at these parameters. The decorative material 10 is then weakened using the laser 20 in order to obtain, for example, weakened decorative material 10 for airbag coverings.

As FIG. 3 shows, essentially only the textile carrier layer 14 is weakened, the thickness of which corresponds to approximately half the thickness of the decorative material 10.

In FIG. 3, the weakness 22 has the shape of a blind hole. The depth of the blind hole corresponds approximately to the thickness of the carrier layer 14.

The parameters for the laser 20 are selected such that, statistically speaking, the weakness 22 extends almost not at all into the adjoining haptic layer 13 or the decorative layer 12.

Once the parameters for the laser 20 have been determined for a batch of the decorative material 10, the number of test surfaces 31 or the number of sections 30 can, for example, be reduced when determining the parameters for the laser 20 for a new batch of the decorative material 10 since, once determined, the parameters may not have to be changed, or they may only need to be changed slightly.

In principle, a whole series of weakened decorative materials 10 can be produced using the method according to the invention, provided that the material properties do not change, for example due to a new batch. To ensure that the weaknesses 22 are properly introduced into the carrier layer 14 of the decorative material 10, random or even periodic sample weaknesses 21 can be introduced into sections 30 of the decorative material 10 for test purposes using the laser 20 set in accordance with step f). The tear property for these sections 30 is verified in accordance with step d). If said property deviates from the desired tear property, steps c) to f) of the method according to the invention are performed once again.

I claim:

1. A Method for introducing weaknesses into a decorative material, in particular airbag coverings in motor vehicles, wherein the method comprises the following steps:
a) providing a decorative material comprising a decorative layer and a carrier layer;
b) providing a laser;
c) introducing different weaknesses by means of the laser into sections of the decorative material for test purposes, wherein the different weaknesses differ from one another in that the different weaknesses are introduced using different parameters of the laser;
d) measuring the tear properties of the sections;
e) determining the section which has a desired tear property and associating the relevant parameters of the laser with this section;
f) setting the laser at the relevant parameters associated in accordance with e);
g) introducing weaknesses into the decorative material by means of the laser set in accordance with step f), wherein the laser is not regulated during the introduction of the weakness.

2. Method according to claim 1, characterized in that the decorative layer is made of plastic, preferably PVC, and particularly preferably PUR.

3. Method according to claim 1, characterized in that the carrier layer is a polymer layer, a textile, a nonwoven fabric, a fiber-polymer mixture, a foam material, a natural fiber, a natural fiber mixture, a knitted spacer fabric, or a combination thereof, or it is a thermoplastic or a thermoplastic resin.

4. Method according to claim 1, characterized in that the decorative material is artificial leather or Alcantara.

5. Method according to claim 1, characterized in that the decorative layer is essentially unweakened.

6. Method according to claim 1, characterized in that impact tests, static tensile tests, or, particularly preferably, dynamic impact tensile tests are used to measure the tear properties of the sections in step d). Method according to claim 1, characterized in that the tensile break strength of the decorative material weakened in accordance with step g) is between 20 N/cm2 and 150 N/cm2, particularly preferably between 50 N/cm2 and 100 N/cm2.

8. Method according to claim 1, characterized in that the laser is an unregulated laser.

9. Method according to claim 1, characterized in that the decorative material is not pretreated.

10. Method according to claim 1, characterized in that the weaknesses are blind holes with a diameter of between 0.1 mm and 2.0 mm.

11. Method according to claim 1, characterized in that the weaknesses are blind holes with a diameter of between 0.3 mm and 1.0 mm.

12. Method according to claim 1, characterized in that the weaknesses are blind holes with a diameter of between 0.5 mm and 0.8 mm.

13. Method according to claim 1, characterized in that the depth of the weaknesses corresponds to the thickness of the carrier layer.

14. Method according to claim 1, characterized in that the depth of the weaknesses corresponds to the thickness of the carrier layer multiplied by from 0.8 to 1.2.

15. Method according to claim 1, characterized in that the positioning of the weaknesses in relation to a preferred direction of elasticity of the decorative material is equal both in the sections and according to step g) introduced in the decorative material.

16. Method according to claim 1, characterized in that the progress of the introduction of the weaknesses is not measured during the introduction of the weakness, in particular not by means of a sensor.

17. Method according to claim 1, characterized in that the sections of the decorative material are a region of the same decorative material or from the same batch of the decorative material.

18. Use of a decorative material produced according to claim 1 as an airbag cover in motor vehicles.

19. An airbag cover for a motor vehicle comprising a decorative layer and a carrier layer, and, having a weakness introduced in the carrier layer and not in the decorative layer, the weakness not visible from a visible side of the decorative layer, and, the decorative material tears in a pre-selected manner when the airbag is triggered.

20. The airbag cover of claim 19 wherein the decorative layer is made from an artificial leather and the carrier layer is made from one selected from a thermoplastic polymer or woven textile.
